(19) United States
(12) Patent Application Publication
(10) Pub. No.: US 2024/0291194 A1
(43) Pub. Date: Aug. 29, 2024

(54) CONNECTOR DEVICE

(71) Applicant: SUMITOMO WIRING SYSTEMS, LTD., Mie (JP)

(72) Inventor: Yuki SUGIMOTO, Mie (JP)

(21) Appl. No.: 18/434,196

(22) Filed: Feb. 6, 2024

(30) Foreign Application Priority Data
Feb. 24, 2023 (JP) 2023-027007

(51) Int. Cl. H01R 13/52

(52) U.S. Cl. CPC H01R 13/5202

(57) ABSTRACT

A connector device 10 includes: a housing 30; a casing 20 that holds the housing 30; and an elastic seal member 60 that is fitted to the housing 30. The housing 30 has, on an outer peripheral surface thereof, a holding groove 37 that receives the elastic seal member 60. The casing 20 includes a first casing 20A and a second casing 20B that are combined with each other with the housing 30 interposed therebetween at a position corresponding to the holding groove 37. The elastic seal member 60 is annular and encloses, when arranged in the holding groove 37, the housing 30 over the entire periphery thereof, the elastic seal member 60 being arranged between the first casing 20A and the second casing 20B. Furthermore, a filling seal part 80 is provided to fill up any gap between the first casing 20A and the second casing 20B.

### CROSS-REFERENCE TO RELATED APPLICATIONS

This application is based on and claims priority from Japanese Patent Application No. 2023-027007, filed on Feb. 24, 2023, with the Japan Patent Office, the disclosure of which is incorporated herein in its entirety by reference.

### TECHNICAL FIELD

The present disclosure relates to a connector device.

### BACKGROUND

JP 2020-053253 A discloses an example of a connector seal structure as a connector device. The connector seal structure includes a housing, and a case to which the housing is attached. The case has a cutout that receives the housing. A cover is mounted to the case with the housing disposed in the cutout. The housing is interposed and held between the case and the cover.

The housing has a holding groove on an outer peripheral surface thereof. An elastic seal member is fitted to the holding groove of the housing. The elastic seal member is in intimate contact with the cutout of the case. The elastic seal member is U-shaped. The housing includes an end locking part that locks the elastic seal member. A space between the housing and the cover is filled with a filling seal.

### SUMMARY

In JP 2020-053253 A, since the elastic seal member is U-shaped, the housing needs to include a locking structure, such as the end locking part, for locking the elastic seal member in a retained state. Accordingly, there is a problem that the housing has a complicated structure. There is also a problem that the elastic seal member cannot easily be attached to the housing due to the U-shape of the elastic seal member.

Therefore, it is an object of the present disclosure to provide a connector device in which an elastic seal member can easily be attached to a housing, and that can avoid a complicated structure of the housing.

According to the present disclosure, a connector device includes: a housing; a casing that holds the housing; and an elastic seal member that is fitted to the housing, wherein the housing has, on an outer peripheral surface of the housing, a holding groove that receives the elastic seal member, the casing includes a first casing and a second casing that are combined with each other with the housing interposed between the first casing and the second casing at a position corresponding to the holding groove, the elastic seal member is annular and encloses, when arranged in the holding groove, the housing over the entire periphery of the housing, the elastic seal member being arranged between the first casing and the second casing, and the connector device further comprises a filling seal part provided to fill up any gap between the first casing and the second casing.

According to the present disclosure, it is possible to provide a connector device in which an elastic seal member can easily be attached to a housing and that can avoid a complicated structure of the housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a front view of a connector device according to Embodiment 1 of the present disclosure.

FIG. 2 is a perspective view of a state when a connector is to be attached to a first casing when viewed from an obliquely upper front position.

FIG. 3 is a perspective view of a state in which the connector is attached to the first casing, and a filling seal part is applied to the upper end face of the side wall of the first casing when viewed from an obliquely upper rear position.

FIG. 4 is a perspective view of a state when a second casing is to be attached to the first casing when viewed from an obliquely upper front position.

FIG. 5 is a traverse cross-sectional view of the connector device taken along a position at which projections are fitted into recesses.

FIG. 6 is a perspective view of the housing when viewed from an obliquely upper front position.

FIG. 7 is a perspective view of an elastic seal member when viewed from an obliquely upper rear position.

FIG. 8 is an enlarged side cross-sectional view of a state in which the filling seal part is provided between lips, according to Embodiment 2 of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure will be listed and described.

(1) According to the present disclosure, a connector device includes: a housing; a casing that holds the housing; and an elastic seal member that is fitted to the housing, wherein the housing has, on an outer peripheral surface of the housing, a holding groove that receives the elastic seal member, the casing includes a first casing and a second casing that are combined with each other with the housing interposed between the first casing and the second casing at a position corresponding to the holding groove, the elastic seal member is annular and encloses, when arranged in the holding groove, the housing over the entire periphery of the housing, the elastic seal member being arranged between the first casing and the second casing, and the connector device further comprises a filling seal part provided to fill up any gap between the first casing and the second casing.

Sealing between the casing (combined first casing and second casing) and the housing can be achieved by the elastic seal member and the filling seal part. Since the elastic seal member is annular enclosing the housing over the entire periphery, it is possible to easily attach the elastic seal member to the housing. Also, the elastic seal member can be held on the housing with its own tension (elastic restoring force). Therefore, there is no need of providing the housing with a complicated locking structure for preventing the elastic seal member from coming off. As a result, it is possible to avoid the housing from having a complicated structure.

(2) In the connector device according to the above-described item (1), preferably, the housing is not in contact with the filling seal part.

Since the elastic seal member encloses the housing over the entire periphery, it is possible to achieve the sealing between the housing and the casing, although the housing is not in contact with the filling seal part. As a result, it is no longer necessary to take into consideration, for example, the adhesion between the housing and the filling seal part, making it possible to simplify the seal structure of the connector device.

(3) In the connector device according to the above-described item (1) or (2), preferably, the elastic seal member has an elastic contact region that is in contact with the casing, and the filling seal part has a filling contact region that is in contact with the casing at a position other than a position at which the elastic seal member is in contact with the casing.

There is no need of providing the filling seal part at a position at which the casing is in contact with the elastic contact region. With this, the above-described configuration can reduce the amount of use of the filling seal part.

(4) In the connector device according to any of the above-described items (1) to (3), preferably, the elastic seal member has, on an outer peripheral surface of the elastic seal member, a plurality of lips that extend in a peripheral direction and are arranged at a distance in a seal width direction, which intersects with the peripheral direction, and the filling seal part fills up at least part of a space formed between the plurality of lips.

The filling seal part can be in contact with the elastic seal member. Here, by filling up the space formed between the plurality of lips of the elastic seal member, the filling seal part can be avoided from leaking from the elastic seal member. As a result, a state in which the gap between the first casing and the second casing is filled with the filling seal part can be realized as appropriate.

(5) In the connector device according to any one of the above-described items (1) to (4), one of the elastic seal member and the housing has a projection that projects in a seal width direction, which intersects with a peripheral direction of the elastic seal member, and the other one has a recess that is recessed in the seal width direction and receives the projection in a fitted state.

Due to the projection being received in the recess in a fitted state, the elastic seal member is positioned and mounted on the housing. Accordingly, when the housing to which the elastic seal member is fitted is attached to the casing, even if the elastic seal member comes into contact with the casing, it is possible to prevent displacement of the elastic seal member with respect to the housing.

### Detail of Embodiments of Present Disclosure

The following will describe specific examples of the present disclosure with reference to the drawings. Note that the present invention is not limited to these examples, but rather is indicated by the scope of claims and is intended to include all modifications within a meaning and scope equivalent to the scope of claims.

### Embodiment 1

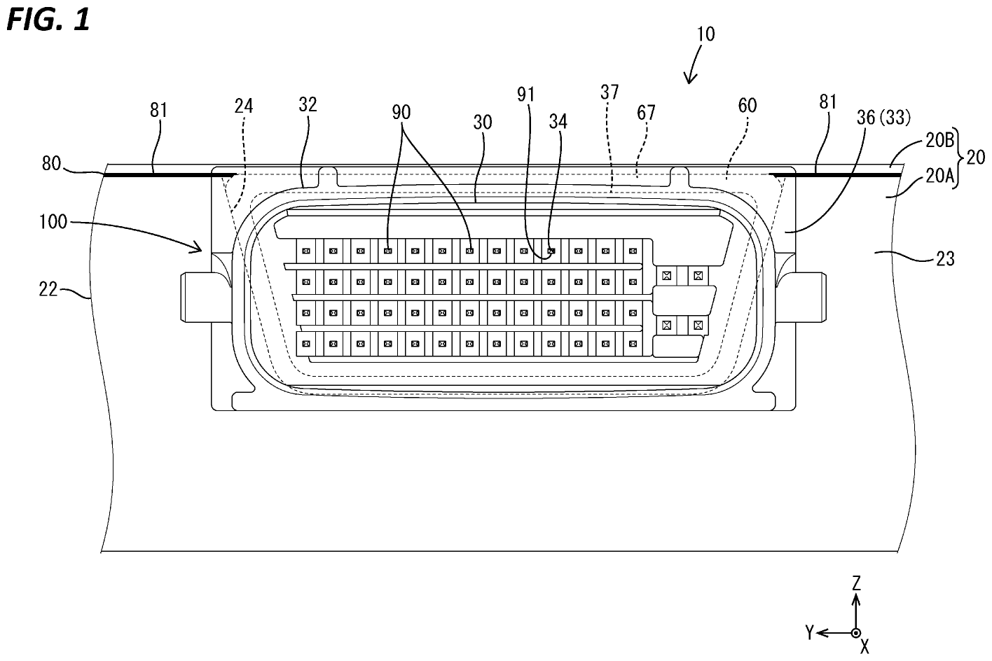

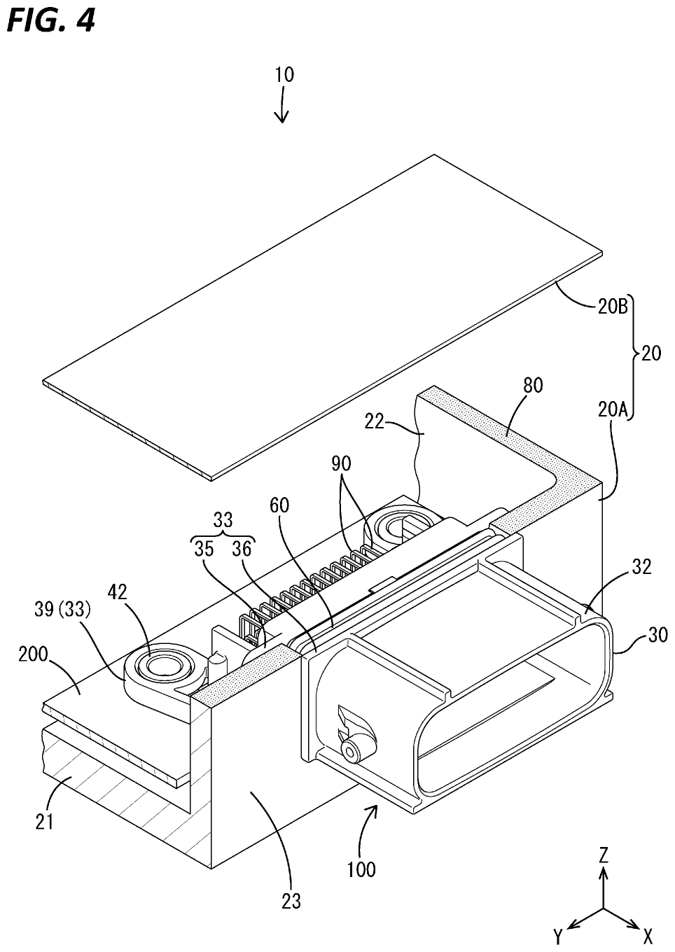

As shown in FIGS. 1 and 4, a connector device 10 according to Embodiment 1 includes a casing 20, a housing 30 held by the casing 20, an elastic seal member 60 fitted to the housing 30, a filling seal part 80 supplied to the casing 20, and a plurality of terminal fittings 90 attached to the housing 30. The housing 30, the terminal fittings 90, and the elastic seal member 60 constitute a connector 100. The housing 30 is placed on the circuit board 200. The terminal fittings 90 are electrically connected to a not-shown conductive path of the circuit board 200. The housing 30 can be fitted to a not-shown counterpart connector. Note that in the following description, with respect to a front-rear direction, the front side refers to a side on which the housing 30 is fitted to the counterpart connector. An up-down direction is based on the vertical direction in FIGS. 1 and 4. In Embodiment 1, the up-down direction corresponds to the obverse-reverse direction of the circuit board 200. A left-right direction is based on the horizontal direction in FIGS. 1 and 4. The reference signs X, Y and Z in FIGS. 1 and 4 indicate forward, leftward, and upward, respectively. These directions do not necessarily correspond to the directions in a state in which the connector device 10 is installed in a vehicle or the like.

### (Casing 20)

The casing 20 is made of a metal or a resin, and includes a first casing 20A serving as a case in which the circuit board 200 is accommodated, and a second casing 20B serving as a cover that is overlaid on the first casing 20A.

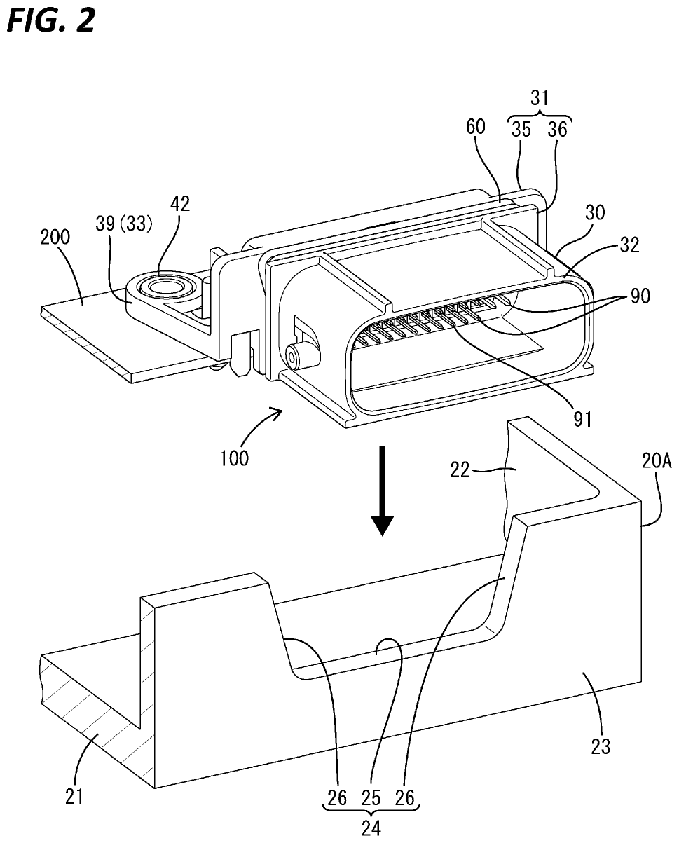

The first casing 20A is box-shaped, and includes, as shown in FIG. 2, a bottom wall 21, and a side wall 22 rising from the bottom wall 21. The first casing 20A is open on the upper side. The circuit board 200 is placed on the bottom wall 21. Although not shown, the side wall 22 is rectangular when viewed in a plan view, and surrounds the circuit board 200. Note that FIG. 2 only shows part of the side wall 22 that includes one of the four corners thereof. The side wall 22 has a wall portion 23 whose wall surface is directed to the front-rear direction. The thickness of the wall portion 23 in the front-rear direction corresponds to the front-rear width (seal width) of the elastic seal member 60.

The wall portion 23 has a reception recess 24 that is open in the upper end face and is U-shaped when viewed in a plan view. The housing 30 to which the elastic seal member 60 is fitted is inserted into the reception recess 24 from above (see FIG. 1). The reception recess 24 has a bottom face 25 located on the bottom side of the reception recess 24 in the depth direction, and a pair of side faces 26 that extend from both the left and right ends of the bottom face 25 to the upper end face of the wall portion 23 with the distance between the side surfaces widened to both left and right sides. That is to say, the reception recess 24 has a shape such that its opening width in the left-right direction increases toward the upper side.

As shown in FIG. 4, the second casing 20B is rectangular flat plate-shaped when viewed in a plan view. In Embodiment 1, the thickness (plate thickness) of the second casing 20B in the up-down direction is less than the thickness of the side wall 22 of the first casing 20A in the front-rear direction. As shown in FIG. 1, the lower surface of the second casing 20B is provided evenly so as to be parallel to the upper end face of the side wall 22 of the first casing 20A (including the upper end face of the wall portion 23). The second casing 20B is disposed so as to cover a rear portion of the housing 30, the terminal fittings 90 drawn from the rear portion of the housing 30, and the circuit board 200, from above. An elastic contact region 67 and a filling contact region 81, which will be described later, are interposed between the peripheral edge portion of the lower surface of the second casing 20B and the upper end face of the side wall 22 of the first casing 20A, and sealing is thus achieved. The second casing 20B is fixed to the first casing 20A using, for example, a fixation means such as not-shown bolts or the like.

### (Terminal Fitting 90)

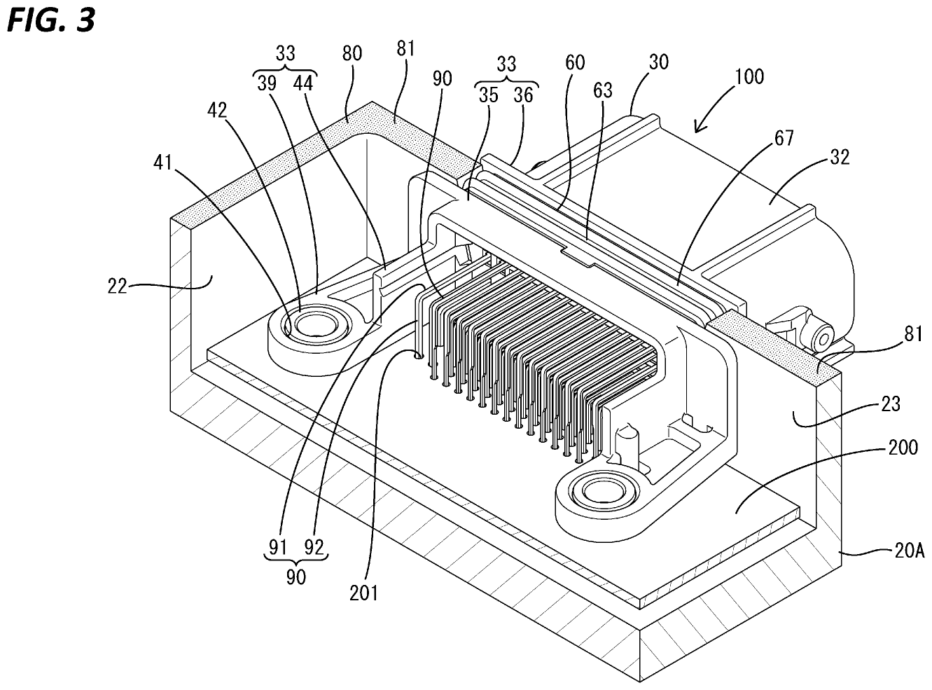

The terminal fittings 90 are made of a conductive metal and are pin-shaped or tab-shaped. As shown in FIG. 3, each terminal fitting 90 includes a counterpart connection portion 91 extending in the front-rear direction, and a board connection portion 92 extending downward from the rear end of the counterpart connection portion 91. The counterpart connection portions 91 are mounted on the housing 30, and are designed to be electrically connected to not-shown counterpart terminal fittings. The board connection portions 92 are exposed to the rear of the housing 30, inserted into through-holes 201 in the circuit board 200, and are soldered and electrically connected to the conductive path of the circuit board 200.

### (Housing 30)

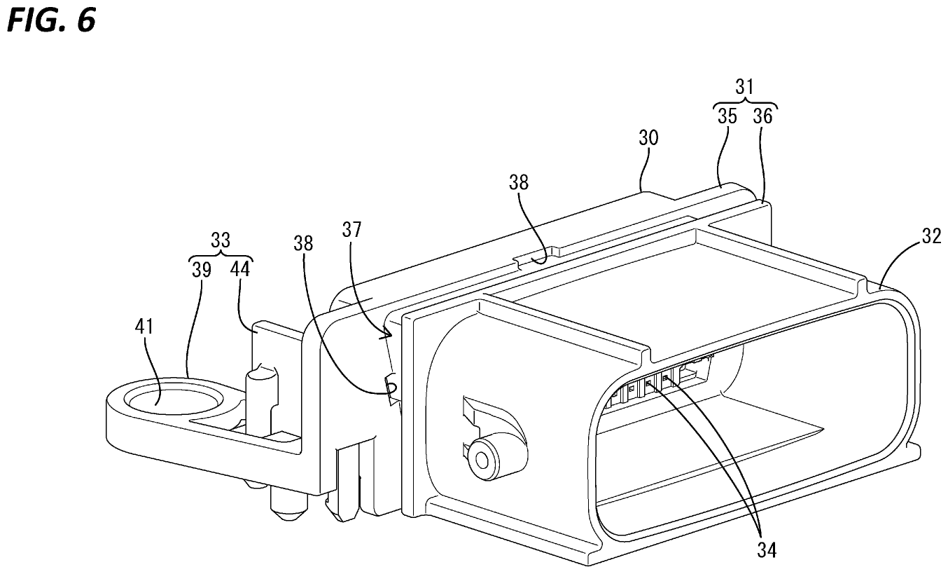

The housing 30 is made of a synthetic resin, and includes, as shown in FIG. 6, a wall-shaped base part 31, a tubular hood part 32 protruding forward from the base part 31, and fixation parts 33 protruding rearward from both left-side and right-side ends of the base part 31 (FIG. 6 only shows the fixation part 33 provided at the left-side end). The base part 31 has an outer shape that corresponds to the reception recess 24. The base part 31 has a plurality of terminal insertion holes 34 passing through the base part 31 in the front-rear direction. The counterpart connection portions 91 of the terminal fittings 90 are respectively passed through the terminal insertion holes 34 in a press-fitted state, and are held (see FIG. 1).

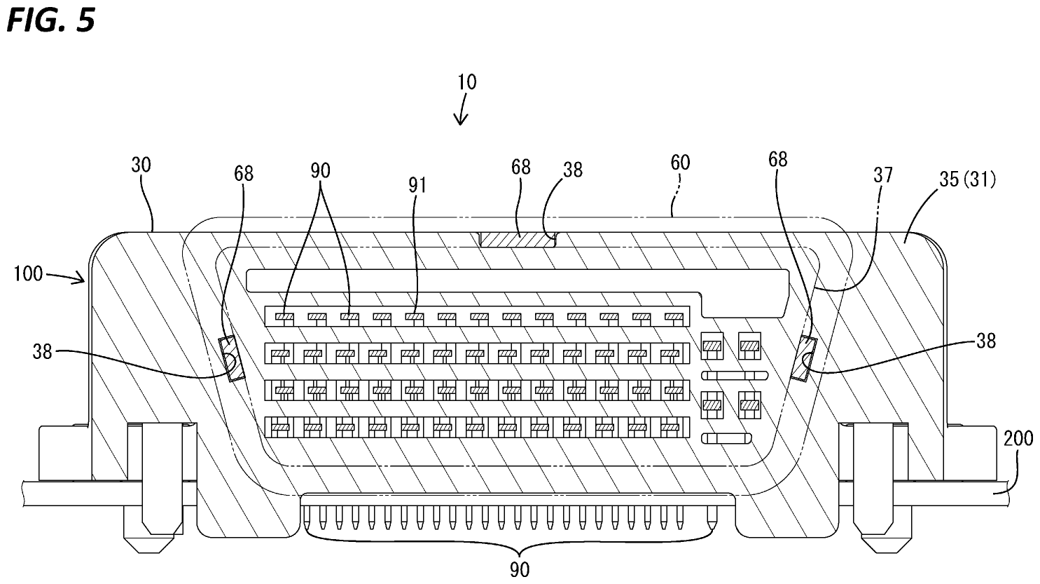

As shown in FIG. 6, the housing 30 has a pair of flange parts 35 and 36 that extend outward from the outer peripheral surface of the base part 31 at positions distanced from each other in the front-rear direction. The flange parts 35 and 36 face each other in parallel and are provided on the outer periphery of the base part 31. The base part 31 has a recess-shaped holding groove 37 between the flange parts 35 and 36, the holding groove 37 extending over the entire periphery of the base part 31. The elastic seal member 60 is attached to the holding groove 37 (see FIGS. 1 and 5). The holding groove 37 has a groove bottom face that is located on the bottom side in its depth direction (direction toward the shaft center of the base part 31) and is continuously formed in the peripheral direction of the base part 31. The holding groove 37 has a trapezoidal cross-section in a manner such that its width in the left-right direction increases toward the upper side, conforming to the shape of the later-described elastic seal member 60.

Of the pair of flange parts 35 and 36, the rear-side flange part 35 has, as shown in FIG. 6, a plurality of recesses 38 that are formed in the front face of the flange part 35 adjacent to the holding groove 37, and are recessed rearward (in the seal width direction of the elastic seal member 60). The recesses 38 are formed in the upper, left, and right sides of the front face of the flange part 35, at distances in the peripheral direction (see FIG. 5). As shown in FIG. 6, the upper-side recess 38 has the shape of a rectangular cutout elongated in the left-right direction when viewed in a plan view, and is provided in the center of the front face of the flange part 35 in the left-right direction. The left and right-side recesses 38 have the shape of a rectangular opening elongated in the up-down direction when viewed from the bottom, and are passed through the flange part 35 at midway portions thereof in the up-down direction. As shown in FIG. 5, later-described projections 68 of the elastic seal member 60 are placed in the respective recesses 38 in a fitted state. Note that the upper end face of the rear-side flange part 35 is covered by the second casing 20B, and thus is located at a position lower to some extent than the upper end face of the front-side flange part 36 (see reference numerals 35 and 36 in FIG. 8, which is the drawing corresponding to later-described another embodiment (Embodiment 2)).

As shown in FIG. 6, the hood part 32 has a square tubular shape with rounded four corners, and protrudes forward from the front-side flange part 36. The front ends of the counterpart connection portions 91 of the terminal fittings 90 protrude into the hood part 32 as shown in FIGS. 1 and 2. The not-shown counterpart connector is to be fitted into the hood part 32 from the front. In a state in which the housing 30 is held by the casing 20, the hood part 32 protrudes forward (while being exposed) from the wall portion 23 (see FIGS. 1 and 3).

As shown in FIG. 6, each fixation part 33 includes a bottom plate part 39 whose plate is directed in the up-down direction, and that protrudes rearward from the rear-side flange part 35. As shown in FIG. 3, the bottom plate parts 39 of the fixation parts 33 are disposed on the upper face of the circuit board 200. Each fixation part 33 has, at a position on the rear end side of the bottom plate part 39 thereof, a fastening hole 41 that is circular when viewed in a plan view, and is passed through the bottom plate part 39 in the up-down direction. A collar 42 is fitted to the inside of the fastening hole 41. A not-shown bolt is inserted into the collar 42 of the fastening hole 41. The bolts are fixed to the circuit board 200. The housing 30 is held on the circuit board 200 via the bolts. Each fixation part 33 includes a side plate part 44 rising from the bottom plate part 39. The side plate parts 44 of the fixation parts 33 cover and protect the rear ends of the counterpart connection portions 91 and the board connection portions 92 from sides.

### (Elastic Seal Member 60)

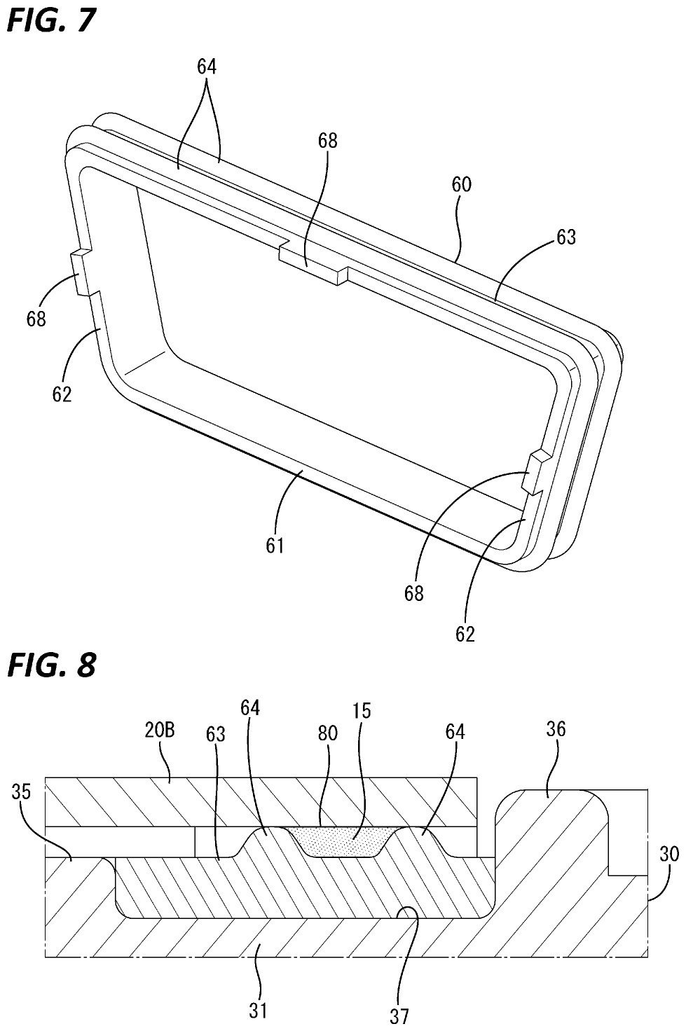

The elastic seal member 60 is made of rubber such as a silicon rubber, and is annular without any discontinuity in the peripheral direction as shown in FIG. 7. The elastic seal member 60 fitted to the holding groove 37 of the housing 30 is inserted into the reception recess 24 and is brought into contact with the first casing 20A, and is further brought into contact with the second casing 20B laid from above, thereby the elastic seal member 60 being interposed between the first casing 20A and the second casing 20B, and the housing 30 in a compressed state (see FIG. 1).

Specifically, as shown in FIG. 7, the elastic seal member 60 includes a bottom part 61 extending in the left-right direction, a pair of side parts 62 extending upward from the left and right side of the bottom part 61 in a manner such that the distance therebetween increases toward the upper side, and an upper part 63 that extends in the left-right direction and connects the upper ends of the side parts 62. The bottom part 61 and the upper part 63 are disposed in parallel to each other. The upper part 63 is elongated in the left-right direction relative to the bottom part 61. The side parts 62 are distanced from each other in the left-right direction in a manner such that the distance therebetween increases toward the upper side. Simply, the elastic seal member 60 has the shape of a trapezoid, specifically, an isosceles trapezoid, with the distance between two sides increasing upward. The elastic seal member 60 has an axisymmetric shape with respect to the axis extending in the center of the elastic seal member 60 in the left-right direction. The four corners (at the ends of the left and right side of the bottom part 61 and the upper ends of the side parts 62) of the elastic seal member 60 are rounded.

The elastic seal member 60 has a constant seal width (front-rear width) in the front-rear direction. The seal width of the elastic seal member 60 corresponds to the thickness of the wall portion 23 (the front-rear dimension of the reception recess 24) and the front-rear dimension of the holding groove 37. The elastic seal member 60 has a pair of lips 64 that protrude at a distance in the seal width direction (front-rear direction). The lips 64 respectively have mountain-shaped cross-sections that have an identical shape and an identical size to each other. The lips 64 are provided over the entire outer peripheral surface of the elastic seal member 60. Each lip 64 serves as the elastic contact region 67 that is in intimate contact with the lower face of the second casing 20B and the inner face (including the bottom face 25 and the side faces 26) of the reception recess 24 in the first casing 20A.

As shown in FIG. 7, the inner peripheral face of the elastic seal member 60 (in FIG. 7, the face directed to the center side (inner side) of the elastic seal member 60) is formed evenly in the peripheral direction, without any projection such as the lips 64. The inner peripheral face of the elastic seal member 60 is in intimate contact with the groove bottom face of the holding groove 37 in the housing 30 over the entire periphery (see FIG. 1). Also, the elastic seal member 60 has a plurality of projections 68 projecting rearward (in the seal width direction) from the thickness portion in the radial direction. The projections 68 project from the upper, left, and right sides of the rear face of the elastic seal member 60, at distances in the peripheral direction. The upper-side projection 68 has the shape of a rectangular plate piece elongated in the left-right direction when viewed in a plan view, and is provided in the center of the rear face of the upper part 63 in the left-right direction. The left and right side projections 68 have the shape of a rectangular plate piece elongated in the up-down direction when viewed in a side view, and are provided in the center of the rear faces of the respective side parts 62 in the up-down direction. In a state in which the elastic seal member 60 is inserted into the holding groove 37 of the housing 30, the projections 68 are placed into the corresponding recesses 38 in a fitted state (see FIG. 5). With this, the elastic seal member 60 is positioned and held on the housing 30.

### (Filling Seal Part 80)

The filling seal part 80 is supplied as a flowable liquid seal such as an adhesive, and is formed as a solid seal obtained as a result of solidification of the liquid seal. For example, a silicon resin adhesive can be used as the filling seal part 80. As shown in FIG. 1, a gap between the first casing 20A and the second casing 20B is filled with the filling seal part 80. In Embodiment 1, the filling seal part 80 is applied to the upper end face of the side wall 22 of the first casing 20A (including the upper end face of the wall portion 23). Once the second casing 20B is overlaid on the first casing 20A, the filling seal part 80 applied to the first casing 20A is brought into intimate contact with the lower face of the second casing 20B. The filling seal part 80 includes the filling contact region 81 that is in intimate contact with the upper end face of the first casing 20A and the lower face of the second casing 20B.

### (Method for Manufacturing Connector Device 10 and Effects of Connector Device 10)

The elastic seal member 60 is attached to the housing 30 from the front. During the attaching process, the elastic seal member 60 is slid on the outer peripheral surface of the hood part 32 and is elastically expanded. Then, the elastic seal member 60 is fitted into the holding groove 37, and the projections 68 enter the respective recesses 38 from the front, so that the elastic seal member 60 is positioned and held on the housing 30. As shown in FIG. 2, the housing 30 to which the elastic seal member 60 is fitted (hereinafter, referred to as the connector 100) is inserted into the reception recess 24 in the wall portion 23 of the first casing 20A in the direction of the arrow in FIG. 2. Specifically, the elastic seal member 60 is inserted into the reception recess 24 from above. Here, the reception recess 24 has a shape such that its opening width in the left-right direction increases toward the upper side, and also the elastic seal member 60 has a shape such that its width in the left-right direction increases toward the upper side. This can avoid the elastic seal member 60 from rigidly coming into contact with the side faces 26 of the reception recess 24 during the insertion process, resulting in a reduction in attaching resistance to the first casing 20A. Moreover, the projections 68 of the elastic seal member 60 are inserted into and fitted to the recesses 38 in the housing 30 in the direction (from the front, in Embodiment 1) that intersects with the insertion direction (downward direction in Embodiment 1) in which the elastic seal member 60 is inserted into the reception recess 24. Accordingly, even if the elastic seal member 60 comes into contact with the side face 26 of the reception recess 24 during the insertion process, it is possible to prevent displacement of the elastic seal member 60 with respect to the housing 30. Thus, the elastic seal member 60 can be inserted into the reception recess 24 in an appropriate state.

In a state in which the elastic seal member 60 is inserted into the reception recess 24, the flange parts 35 and 36 are arranged so as to sandwich the wall portion 23 in the front-rear direction. With this, the connector 100 is held while being positioned with respect to the wall portion 23 in the front-rear direction. At this time, the upper end faces of the lips 64 protrude upward from the upper end face of the wall portion 23.

Subsequently, as shown in FIG. 3, the filling seal part 80 is applied to the upper end faces of the side walls 22. However, the filling seal part 80 may be applied to the upper end faces of the side walls 22 before the connector 100 is held by the wall portion 23. Note that FIG. 3 and the like schematically show the filling seal part 80, and the actual thickness and application amount of the filling seal part are not shown.

In Embodiment 1, the filling seal part 80 is applied to the upper end face of the wall portion 23 except for the region from which the upper part 63 of the elastic seal member 60 is exposed. On the upper end face of the wall portion 23, parts of the filling contact region 81 of the filling seal part 80 are arranged on both sides with the elastic contact region 67 of the elastic seal member 60 interposed therebetween, and are aligned with the elastic contact region 67 in the left-right direction.

Subsequently, the second casing 20B is overlaid on the first casing 20A. Specifically, the second casing 20B is placed on the upper end face of the side wall 22 of the first casing 20A. The filling seal part 80 is attached to the lower surface of the second casing 20B. Then, the filling contact region 81 of the filling seal part 80 is solidified, and is adhered to the first casing 20A and the second casing 20B. The elastic contact region 67 of the elastic seal member 60 (the lips 64 of the upper part 63) is in intimate contact with the lower surface of the second casing 20B. As a result of the first casing 20A and the second casing 20B being fixed into a combined state by bolting or the like, the intimate state of the elastic contact region 67 with respect to the second casing 20B is maintained. The gap between the housing 30 and the casing 20 is sealed by the elastic seal member 60 and the filling seal part 80, and sealing is thus achieved. The gap between the combined first casing 20A and second casing 20B is sealed by the filling seal part 80, and sealing is thus achieved.

As described above, according to Embodiment 1, using the elastic seal member 60 and the filling seal part 80, it is possible to seal the gap between the casing 20 (the combined first casing 20A and second casing 20B) and the connector 100. Here, the elastic seal member 60 is annular enclosing the housing 30 over the entire periphery. Therefore, according to Embodiment 1, it is possible to easily attach the elastic seal member 60 to the housing 30. Also, the elastic seal member 60 can be held on the housing 30 with its own tension (elastic restoring force). Therefore, according to Embodiment 1, there is no need of providing the housing 30 with a complicated locking structure for preventing the elastic seal member 60 from coming off. Accordingly, Embodiment 1 can avoid the housing 30 from having a complicated structure.

The outer periphery of the housing 30 is sealed over the entire periphery by the elastic seal member 60 at a position that corresponds to the casing 20. In other words, the elastic seal member 60 is interposed between the housing 30 and the casing 20. Accordingly, although the housing 30 is not in contact with the filling seal part 80, it is possible to achieve sealing between the housing 30 and the casing 20. As a result, it is no longer necessary to take into consideration, for example, the adhesion between the housing 30 and the filling seal part 80, making it possible to simplify the seal structure of the connector device 10.

Also, in Embodiment 1, the elastic seal member 60 has the elastic contact region 67 that is in contact with the casing 20, and the filling seal part 80 has the filling contact region 81 that is in contact with the casing 20 at a position other than the position at which the elastic seal member is in contact with the casing 20. Accordingly, in Embodiment 1, there is no need of providing the filling seal part 80 at a portion of the casing 20 that corresponds to the elastic contact region 67. As a result, the configuration of Embodiment 1 can reduce the amount of use of the filling seal part 80.

### Embodiment 2

In Embodiment 2 of the present disclosure, as shown in FIG. 8, a contact portion 15 is provided in which the elastic seal member 60 and the filling seal part 80 are partially in contact with each other, and sealing is also achieved by the contact portion 15. Other configuration is the same as in Embodiment 1, and the same reference numerals are given to the same configurations as those in Embodiment 1, and redundant description is omitted.

The contact portion 15 is formed, for example, between the upper end portions (left and right corners at the upper ends) of the side parts 62 of the elastic seal member 60, and the portion of the filling seal part 80 adjacent to the reception recess 24. As shown in FIG. 8, the contact portion 15 is formed by part of the filling seal part 80 entering the space between the lips 64 of the elastic seal member 60 so as to fill up the space. In the contact portion 15, the filling seal part 80 is accommodated in the space between the lips 64, and is configured not to leak from the elastic seal member 60. The leak prevention structure of the filling seal part 80 can be realized by adjusting the distance between the lips 64, the groove depth, and the like. Accordingly, a state in which the gap between the first casing 20A and the second casing 20B is filled with the filling seal part 80 can be realized as appropriate.

### Other Embodiments of Present Disclosure

Above-described Embodiment 1 disclosed herein is an example in all respects and should be construed as non-limiting.

In Embodiment 1, a pair of lips protrude from the outer peripheral surface of the elastic seal member, at a distance in the front-rear direction. In contrast, according to another embodiment, three or more lips may protrude from the outer peripheral surface of the elastic seal member, at a distance in the front-rear direction, or one lip may protrude from the outer peripheral surface of the elastic seal member. Furthermore, a configuration is also possible in which no lip is provided on the outer peripheral surface of the elastic seal member.

In Embodiment 1, the first casing is configured as a case in which the circuit board and the like are accommodated, and the second casing is configured as a cover that covers the opening of the first casing on the upper side. In contrast, according to another embodiment, the first casing and the second casing may be configured as casings indistinguishable between the case and cover. Essentially, it is sufficient that the first casing and the second casing are formed so as to be combinable to each other with the connector (the housing and the elastic seal member) interposed therebetween.

In Embodiment 1, the filling seal part is first applied to the first casing, and then is attached to the second casing upon combination of the first casing and the second casing. In contrast, according to another embodiment, the filling seal part may first be applied to the second casing, and then may be attached to the first casing upon combination of the first casing and the second casing. Furthermore, a configuration is also possible in which the filling seal part is injected to fill up the gap between the combined first casing and second casing, using a caulk gun or the like.

In Embodiment 2, the contact portion is formed between the left and right corners at the upper ends of the elastic seal member, and the ends of the filling seal part. In contrast, according to another embodiment, the contact portion may be formed as a result of, for example, the filling seal part filling up the space between the upper part of the elastic contact region and the second casing over the entire length of the upper part in the left-right direction. In this case, the filling seal part may fill up the gap formed between the lips of the elastic seal member, as in Embodiment 2.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector device comprising
a housing;
a casing that holds the housing; and
an elastic seal member that is fitted to the housing,
wherein the housing has, on an outer peripheral surface of the housing, a holding groove that receives the elastic seal member,
the casing includes a first casing and a second casing that are combined with each other with the housing interposed between the first casing and the second casing at a position corresponding to the holding groove,
the elastic seal member is annular and encloses, when arranged in the holding groove, the housing over the entire periphery of the housing, the elastic seal member being arranged between the first casing and the second casing, and
the connector device further comprises a filling seal part provided to fill up any gap between the first casing and the second casing.

2. The connector device according to claim 1,
wherein the housing is not in contact with the filling seal part.

3. The connector device according to claim 1,
wherein the elastic seal member has an elastic contact region that is in contact with the casing, and the filling seal part has a filling contact region that is in contact with the casing at a position other than a position at which the elastic seal member is in contact with the casing.

4. The connector device according to claim 1,
wherein the elastic seal member has, on an outer peripheral surface of the elastic seal member, a plurality of lips that extend in a peripheral direction and are arranged at a distance in a seal width direction, which intersects with the peripheral direction, and
the filling seal part fills up at least part of a space formed between the plurality of lips.

5. The connector device according to claim 1,
wherein one of the elastic seal member and the housing has a projection that projects in a seal width direction, which intersects with a peripheral direction of the elastic seal member, and the other one has a recess that is recessed in the seal width direction and receives the projection in a fitted state.
